(19) United States
(12) Patent Application Publication
(10) Pub. No.: US 2003/0193654 A1
(43) Pub. Date: Oct. 16, 2003

(54) Laser display system

(76) Inventor: Wayne R. Ushinski, Plainville, CT (US)

Correspondence Address: ALIX YALE & RISTAS LLP, 750 MAIN STREET, SUITE 1400, HARTFORD, CT, 06103, US

(21) Appl. No.: 10/411,608

(22) Filed: Apr. 10, 2003

Related U.S. Application Data
(60) Provisional application No. 60/371,798, filed on Apr. 11, 2002.

(51) Int. Cl. G03B 21/28

(52) U.S. Cl. 353/50

(57) ABSTRACT

A laser display system employs at least one laser module which is energizeable to project a laser beam. The laser beam intersects a rotating crystal or optical element which is mounted above the top of a housing. A variable light display is projected into the surrounding region.

### CROSS-REFERENCE TO RELATED APPLICATION

This application claims the priority of U.S. Provisional Application No. 60/371,798 filed on Apr. 11, 2002.

### BACKGROUND OF THE INVENTION

This invention relates generally to laser systems which provide a light display which is generated by a laser light source. More specifically, this invention relates to a laser display system which is constructed of relatively inexpensive components.

### SUMMARY OF THE INVENTION

Briefly stated, the invention in a preferred form is a laser display system wherein at least one laser source generates a laser beam. An optical element is interposed in the beam. A motor assembly rotates the optical element so that a continuously variable optical display is continuously projected into the surrounding region.

A motor assembly, preferably comprising an electric motor which drives a shaft is operatively connected to the optical element. The motor and at least a portion of the laser source are housed within an enclosure. Preferably, there are a plurality of laser sources and the enclosure forms an aperture for each of the laser sources. A mounting assembly may be provided wherein the angle of the generated laser beam relative to the central axis of the housing enclosure may be varied for each of the laser sources. In one form of the invention, the enclosure comprises one more hinged panels which each mount a laser source.

In one embodiment, the optical element is threadably mounted to the shaft. The axial position of the optical element with respect to the axis of rotation may vary as the element rotates. A globe may optionally surround the laser display system.

In one preferred embodiment, a table housing which has a base and a top portion includes a central axis. The optical element is mounted above the top portion of the housing. A motor assembly continuously rotates the optical element. At least one, and preferably a plurality of modules, are mounted in fixed angular relationship to the housing central axis. The laser modules generate an optical output which intersects the optical element so that when at least one laser module is energized, a laser beam intersects the rotating optical element to produce a variable light display which is projectable onto surrounding structures. The plurality of laser modules are angularly spaced about the central axis of the housing.

The optical element may comprise a ball which has a plurality of irregular shapes at the surface. An assembly may be provided to continuously axially displace the optical element as the element rotates. In one embodiment, there are six equiangular spaced laser modules. At least a portion of the motor assembly and at least a portion of each of the laser modules is positioned within the housing. In one embodiment, the optical element comprises a crystal of symmetric uniform geometric faces which reflects and refracts light. The laser display system may also include a second optical element which can be substituted for the first optical element and which produces a variable light display different than that of the first optical element.

An object of the invention is to provide a new and improved laser display system which has an efficient construction and a relatively compact form.

Another object of the invention is to provide a new and improved laser display system which is capable of providing a wide variety of laser displays.

A further object of the invention is to provide a new and improved laser display system which provides for a continuous multi-directional laser light display.

Other objects and advantages of the invention will become apparent from the detailed description and the drawings.

### BRIEF DESCRIPTION OF THE DRAWINGS

FIG. 1 is an exploded view, partly in schematic, of a first embodiment of a laser display system in accordance with the present invention, including a representation of a laser cannon and a schematic of various optional elements;

FIG. 2 is a top plan view of a second embodiment of a laser display system in accordance with the present invention;

FIG. 3 is a perspective view, partly in schematic, of an integrated laser display system in accordance with the present invention;

FIG. 4 is a side sectional view, partly in schematic and partly in phantom, of another embodiment of the laser display system in accordance with the present invention;

FIG. 5 is a top plan view of the laser display system embodiment of FIG. 4;

FIG. 6 is a bottom view of the laser display system embodiment of FIG. 4;

FIG. 7 is an enlarged fragmentary sectional view of a crystal subassembly which may be employed in the laser display system embodiment of FIG. 4;

FIG. 8 is a side sectional view, partly in schematic and partly in phantom, of a modified embodiment of the laser system of FIG. 4;

FIG. 9 is a schematic view of the laser system of FIG. 8;

FIG. 10 is an enlarged fragmentary sectional view of a crystal subassembly that may be employed in the embodiment of FIG. 8; and

FIG. 11 is an interior view of the laser display embodiment of FIG. 4, view generally from the bottom thereof.

### DETAILED DESCRIPTION OF THE PREFERRED EMBODIMENTS

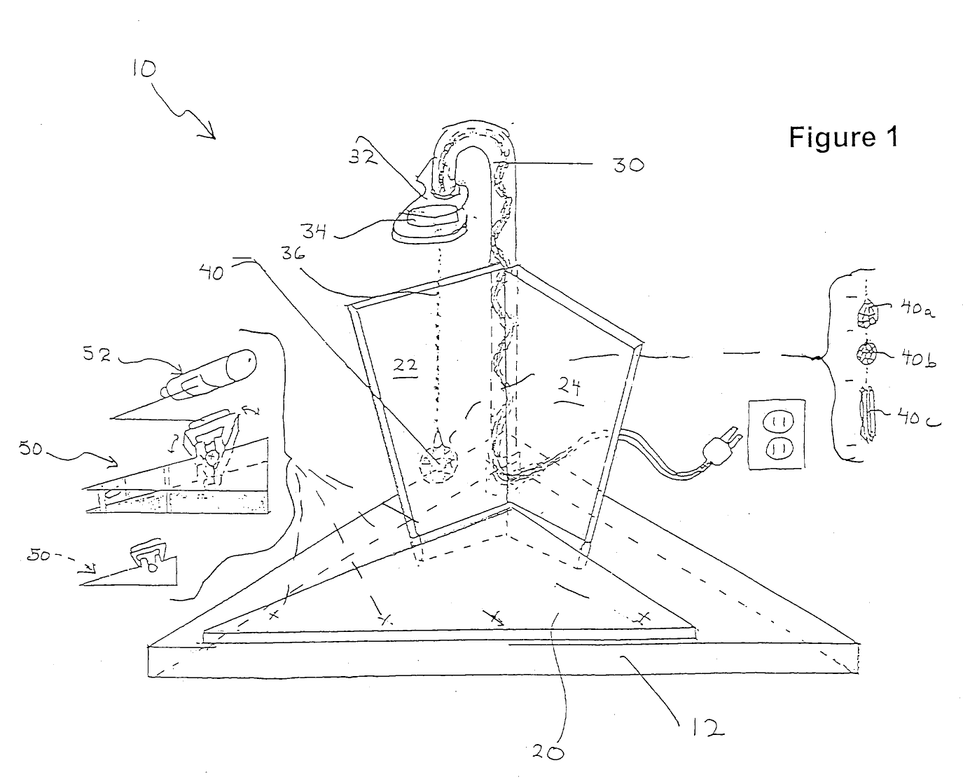

With reference to FIG. 1, a first embodiment of the laser display system is employed to provide a continuously varying laser display from a module generally designated by the numeral 10. The laser display module 10 includes a triangular base 12 which may be formed of any suitable materials such as wood, plastic or metal. A mirror 20 is supported on the base in a generally horizontal orientation. The base mirror 20 forms a vertex. A pair of mirrors 22, 24 projects generally upwardly at the location of the vertex in an oblique orientation. In one form of the invention, the mirrors 22, 24 are tilted rearwardly at an angle of approximately 65° to 70°. Each of the mirrors may be a quarter-inch standard mirrors which are suitably cut. In one form of the invention, the principal mirror 22 has a height of approximately 8 inches, an upper dimension of approximately 7 inches, and a lower dimension of approximately 4¼ inches, thereby forming an irregular quadrilateral shape.

A lamp pipe 30 extends upwardly from the support base 12. The pipe supports a platform 32 which mounts an electric motor 34 having a gear reduction, preferably providing a very slow turning, such as approximately 0.5 revolutions per minute. Suspended from the motor shaft is a cable 36 which at a lower end mounts a plastic crystal 40 which functions as a reflecting element.

A laser cannon 50, which may employ a pin type laser 52, such as employed in a laser key chain, is mounted and oriented at locations X of the base so that upon energization, the laser beam (not illustrated) intersects the plastic crystal 40. The angular orientation of the cannon 50 may be varied by repositioning relative to a base.

The crystal 40 may assume various forms such as an oblong type configuration 40a, an irregular circular configuration 40b or an elongated configuration 40c as illustrated. The electric motor 34 is turned on, which causes the crystal 40 to essentially rotate. The laser light from one or more cannons 50 is directed at the crystal, which upon rotation, reflects (and/or refracts) the laser light so that a visually striking pattern is displayed around the room. Naturally, the angle of the laser cannon 50 may be varied and the reflective surface of the crystal 40 may be varied to reflect various light patterns. In addition, the relative height of the crystal 40, i.e., the horizontal point of intersection of the laser beam with the crystal, may also be varied to change the laser light display in the surrounding room.

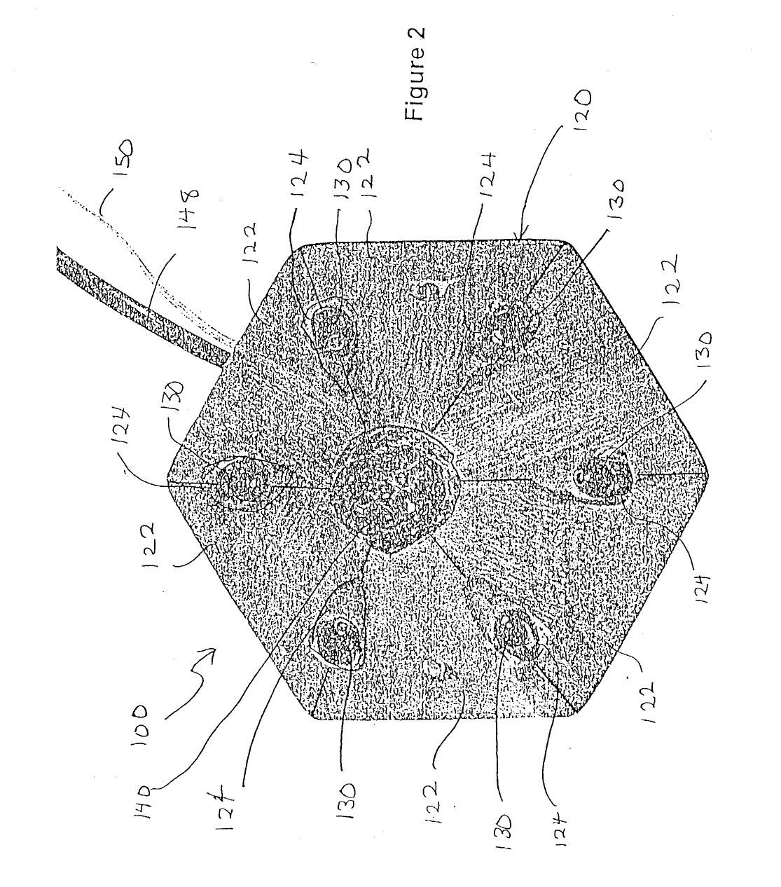

A second embodiment of a laser display system is generally designated by the numeral 100 in FIG. 2. Laser display module 100 includes a six-sided support base (not illustrated) which mounts a six-sided housing 120 comprising panels 122 which converge toward an apex at an upper portion thereof. A recess 124 is found adjacent intermediate locations of each of the intersections of the panels 122. A penlight laser 130 is mounted at each recess 124 and aimed toward the apex.

An acrylic plastic ball 140 which has been suitably melted to provide a very irregular shape is mounted on a shaft at the apex location. An electric motor (not illustrated), such as a Whirlpool™ electric dryer or washer motor, which provides a low revolution rate such as 0.5 revolutions per minute, is mounted at the interior of the housing. A variable speed motor may be provided. The lasers are powered by a 4.5 volt 1000 ma transformer which plugs via cord 148 into a standard 110-volt outlet.

The lasers may be manually energized or, alternatively, an electric lead 150 may extend into the interior of the housing and connect with a power source for energizing the lasers. In one preferred embodiment, each laser 130 may be a class III A type laser such as a compact keychain type laser. Other laser sources may also be employed. Each of the laser beams intersects the ball 140 which functions as a refracting/reflecting element. When the ball motor is energized, the ball 140 rotates to provide a visually striking display pattern to the surrounding structures. The reflecting ball or crystal 140 may be replaced with other alternative crystals to provide a different visual display. In addition, the height of the crystals relative to the fixed angles of the lasers 130 can be varied to also change the display pattern. A rainbow effect may be produced by intersecting three laser beam colors at a selected point of the reflecting element.

The laser assembly may be employed with auxiliary elements such as a smoke machine enhance the visual effect.

A wide variety of crystal elements 40, 140 may be employed. The elements may be made from acrylic knobs which have various cuts, shapes and sizes, cut glass knobs, and hand blown glass balls. Melted reformed acrylic knobs are also highly suitable. For example, a round diamond cut acrylic crystal may show one dot and turn into four and into eight, then all connect with red lines greeting a three dimensional box which appears to fill with smoke and disappear. Different cuts of the crystal element will result in different shapes such as boxes, triangles and circles. The melted reformed acrylic knob is visually striking in that it may suggest a tornado in motion or storm clouds passing overhead, then reappearing and disappearing. Each of the laser beams intersects the crystal at an angle which will provide highly striking visual effects. For example, a white laser on a prism diamond cut crystal may provide a rainbow effect. The elements 40, 140 may also be quasi-spherical members have a symmetric uniform geometric face configuration.

In addition, pivoting laser holders such as laser cannons can be placed throughout a room and aimed at the reflecting element to add an additional variation and highly striking visual effect to the laser assembly.

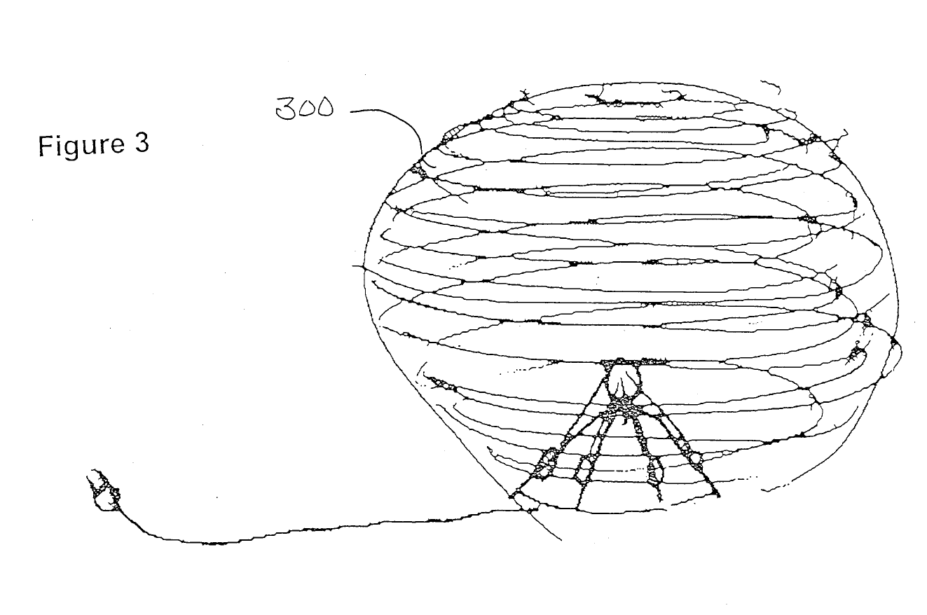

With reference to FIG. 3, a globe 300 manufactured from white rice paper may be placed over the previously described laser modules 10 and 100. Various shapes and dimensions of the globe may be employed. Alternatively, a translucent globe or a thin white plastic globe may also be employed.

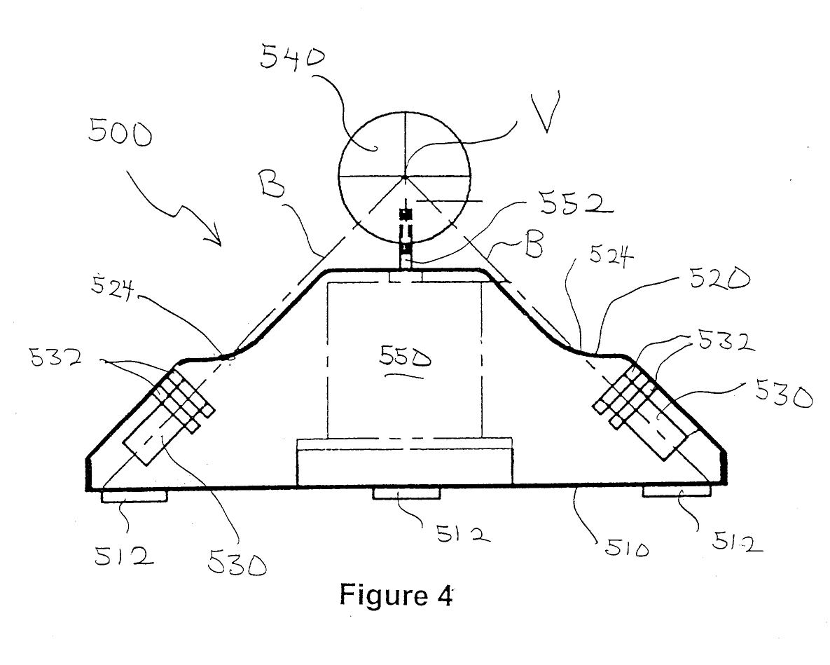

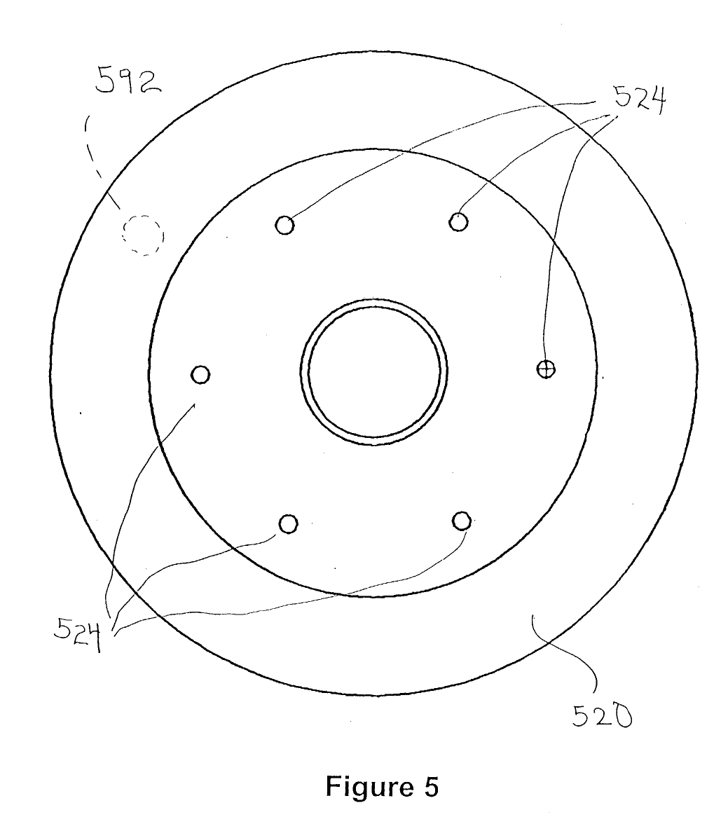

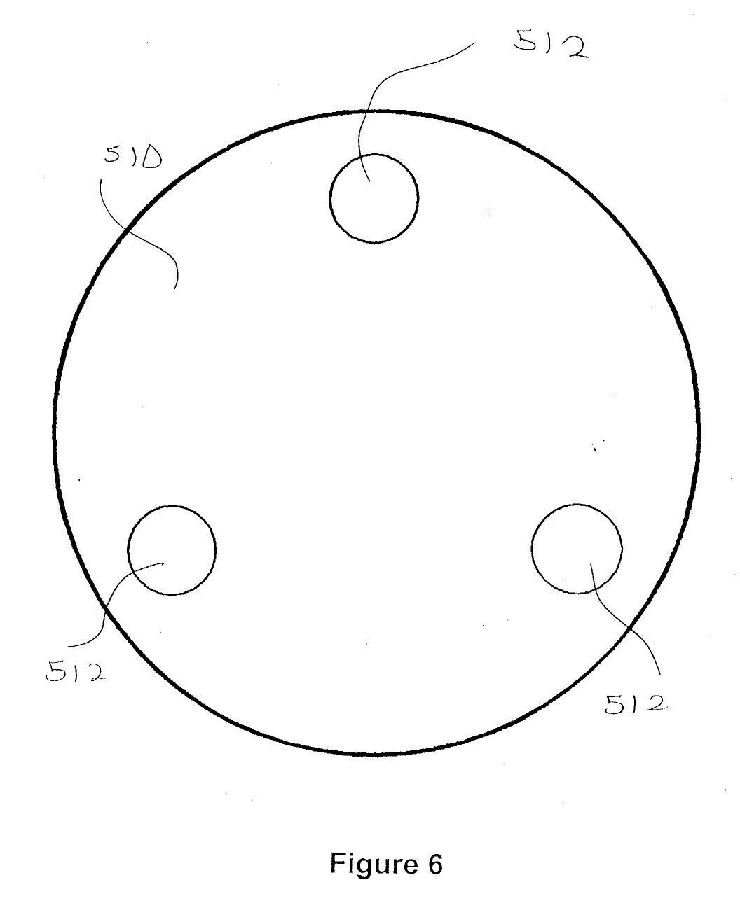

With reference to FIGS. 4-7 and 11, another embodiment of a laser display module in the form of a table-top module is generally represented by the numeral 500. The laser display system includes a volcano-like shaped housing 520 which is contoured and forms an upper crater with a plurality of angularly spaced apertures 524. The housing 520 may be manufactured from durable plastic. The lasers 530 are preferably 4.5 volt class III A-type lasers which are secured by brackets 532 to the underside of the housing 520. One (1) to six (6) lasers 530 may be employed in the preferred embodiments of the invention. The lasers may be oriented so that the axis of their optical beams B intersect at a vertex V at the center of the optical element 540. Element 540 may be similar in structure to elements 40, 140. With reference to FIGS. 4 and 6, the underside base 510 of the housing may mount three support pads 512.

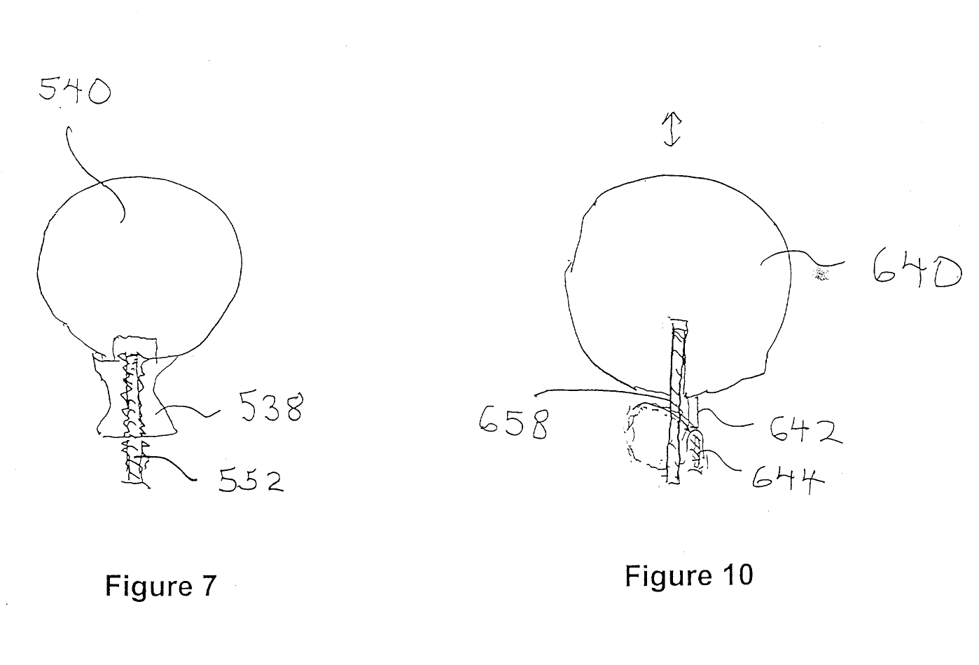

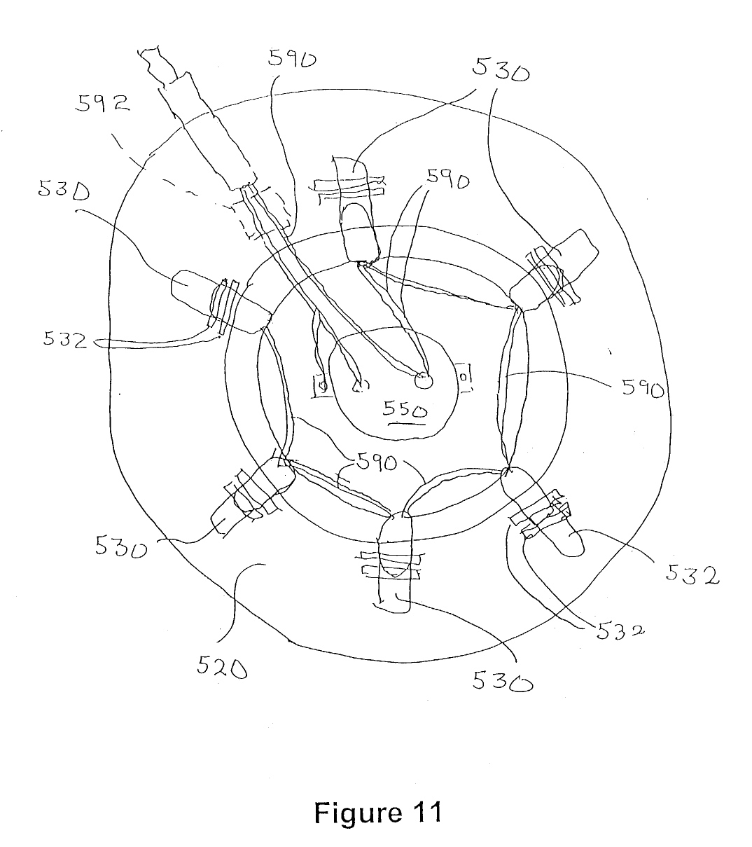

An electric motor 550 is mounted at the interior of the housing. The motor preferably operates at a low revolution rate. The motor 550 may be a 3 volt, 6 ma electric motor which operates at 0.5 rpm or may be a variable speed motor. The motor 550 preferably drives a threaded shaft 552 which receives a coupling portion 538 of an optical element 540 as best illustrated in FIG. 7. The optical element 540 is threadably received on the shaft 552 and may be easily dismounted and replaced by another optical element (not illustrated) to provide variation in the optical display. The electrical leads 590 to the motor 550 and the lasers 530 may be separately connected or ganged in series as illustrated in FIG. 11. An on/off switch 592 may alternately be provided. When the lasers 530 are energized and the motor 550 is energized, the optical element 540 rotates to provide a visually striking, multi-dimensional and variable display pattern on the surrounding walls, ceiling and floor.

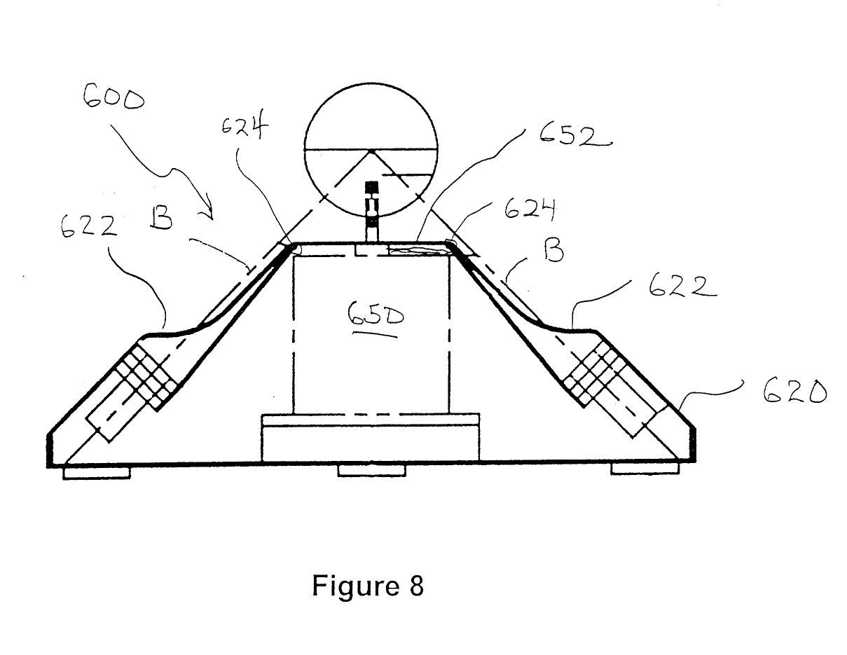

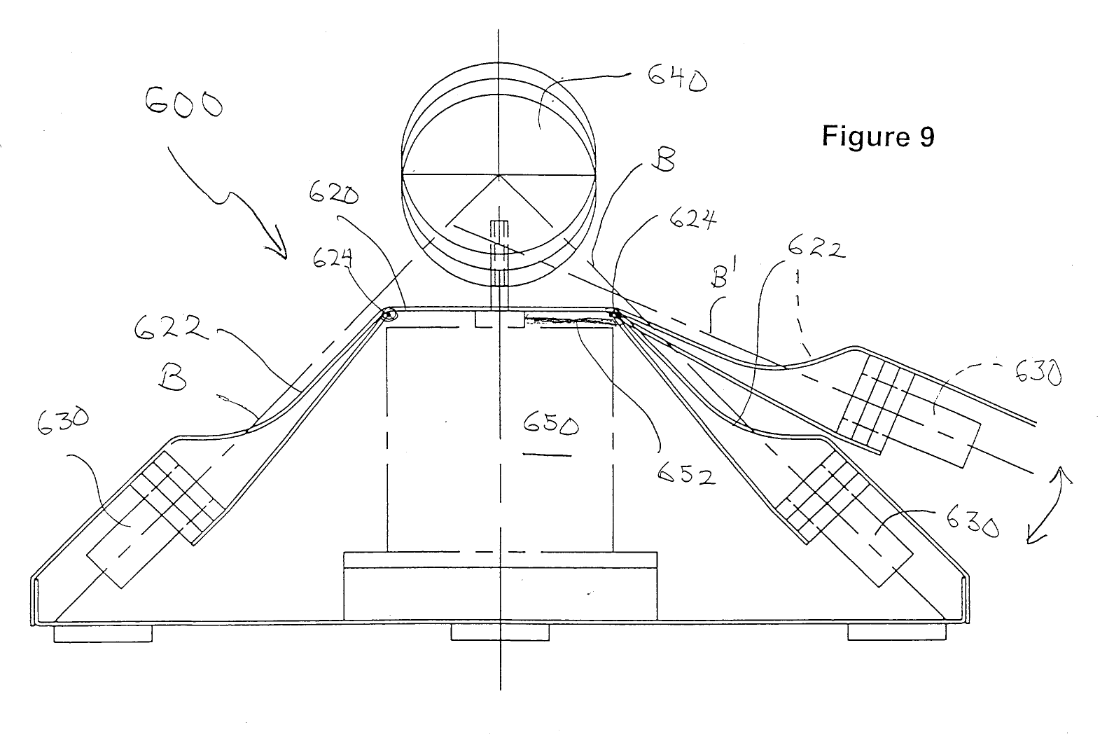

With reference to FIGS. 8-10, the laser display assembly designated generally by the numeral 600 is capable of providing enhanced variability to the visual display pattern. The housing module 620 includes panels 622 which are hinged at pivot axis 624 to allow for the angular relationship between the laser beam B, Bl and the optical element 640 to vary as illustrated in FIG. 9. The position of the lasers may be suitably altered by an arm 652 or a cam member which is also rotably driven by the motor 650. In addition, the drive shaft assembly is provided with a worm gear (not illustrated) or a follower 642 interacts with a cam 644 so that as the drive shaft 658 of the motor rotates, the spacing between the crystal or optical element 640 and the top of the housing 620 is continuously varied to provide additional variability to the intersection of the laser beams and the optical element as illustrated in FIG. 10. In this embodiment, the drive shaft 658 may have a cross (+) shaped section which engages a complementary slot of the optical elements 640 to rotatably couple the components.

While preferred embodiments of the foregoing invention have been set forth for purposes of description of illustration, the foregoing description should not be deemed a limitation of the invention herein. Accordingly, various modifications, adaptations and alternatives may occur to one skilled in the art without departing from the spirit and the scope of the present invention.

What is Claimed:

1. A laser display system comprising:
at least one laser source generating a laser beam;
an optical element interposed in said beam; and
a motor assembly for rotating the optical element relative to the at least one laser beam so that a continuously variable optical display is continuously projected into the surrounding region.

2. The laser display system of claim 1, wherein said motor assembly comprises an electric motor which drives a shaft operatively connected to said optical element.

3. The laser display system of claim 1, wherein said motor and at least a portion of said laser source is housed within an enclosure.

4. The laser display system of claim 3, wherein there are a plurality of laser sources and said enclosure defines an aperture for each said laser source.

5. The laser display system of claim 4, wherein the enclosure defines a central axis and further comprising a mounting assembly wherein the angle of the laser beam relative to the central axis may be varied.

6. The laser display system of claim 5 wherein said enclosure comprises a hinged panel which mounts a laser source.

7. The laser display system of claim 2, wherein said optical element is threadably mounted to said shaft.

8. The laser display system of claim 1 wherein the optical element has an axis of rotation and the axial position of said element with respect to said axis of rotation varies as the element rotates.

9. An integrated system comprising a globe surrounding the laser display system of claim 1.

10. A laser display system comprising:
a housing having a base and a top portion and a central axis;
an optical element mounted above a top portion of the housing;
a motor assembly for continuously rotating said optical element;
at least one laser module mounted in fixed angular relationship to said housing central axis and defining an optical output which intersects said optical element,
so that when said at least one laser module is energized, a laser beam intersects said rotating optical element to produce a variable light display which is projectable onto surrounding structures.

11. The laser display system of claim 10, further comprising a plurality of laser modules angularly spaced about the central axis of said housing.

12. The laser display system of claim 10, wherein said optical element comprises a quasi-spherical ball having a plurality of geometric shapes at the surface thereof.

13. The laser display system of claim 10, wherein said motor assembly comprises a rotatable shaft which is threaded, said optical element being threadably mounted to said shaft.

14. The laser display system of claim 10, further comprising an assembly which continuously axially displaces said optical element as said optical element rotates.

15. The laser display system of claim 10, wherein there are six equiangularly spaced laser modules.

16. The laser display system of claim 10 wherein at least a portion of said motor assembly and at least a portion of each said laser module is positioned within said housing.

17. A laser display system comprising:
a housing having a base and a top portion and a central axis;
an optical element mounted above a top portion of the housing;
a motor mounted in said housing having a shaft operatively connected to said optical element for continuously rotating said optical element;
a plurality of laser modules mounted in said housing in fixed angular relationship to said housing central axis and defining an optical output which is oriented at an acute angle with said base and intersects said optical element,
so that when said laser modules are energized, the laser beams intersect said rotating optical element to produce a variable light display which is projectable onto surrounding structures.

18. The laser display system of claim 17, wherein said optical element comprises a ball-like crystal which reflects and refracts light.

19. The laser display system of claim 17, wherein said shaft is threaded, said optical element being threadably mounted to said shaft.

20. The laser display system of claim 17, further comprising a second optical element which may replace the first optical element and which produces a variable light display which is different than that of the first optical element.
